(19) United States
(12) Patent Application Publication
(10) Pub. No.: US 2013/0284477 A1
(43) Pub. Date: Oct. 31, 2013

(54) OVERLOAD COUPLING

(71) Applicant: Willy Braun, Neustetten (DE)

(72) Inventor: Willy Braun, Neustetten (DE)

(73) Assignee: Robert Bosch GmbH, Stuttgart (DE)

(21) Appl. No.: 13/881,711

(22) PCT Filed: Sep. 21, 2011
(86) PCT No.: PCT/EP2011/066374

§ 371 Date: Jul. 10, 2013

(30) Foreign Application Priority Data
Oct. 27, 2010 (DE) 10 2010 042 981.3

(51) Int. Cl. B23Q 11/04

(52) U.S. Cl. CPC B23Q 11/04
USPC 173/176

(57) ABSTRACT

A power tool device, in particular a hammer drill device and/or a chisel device, includes at least one torque limiting unit that is configured to limit a torque in a drivetrain in at least one operating state. The at least one torque limiting unit includes at least two force transmission mechanisms configured to transmit the torque in the at least one operating state. The at least two force transmission mechanisms have different transmission characteristics.

### PRIOR ART

There is already known from DE 100 02 748 A1 a power tool device, in particular a hammer drill device and/or a chisel device, having a torque limiting unit that is provided to limit a torque in a drive train in at least one operating state, and that comprises seven force transmission means, which are provided to transmit the torque in at least one operating state.

### DISCLOSURE OF THE INVENTION

The invention is based on a power tool device, in particular a hammer drill device and/or a chisel device, having at least one torque limiting unit that is provided to limit a torque in a drive train in at least one operating state, and that comprises at least two force transmission means, which are provided to transmit the torque in at least one operating state.

It is proposed that the at least two force transmission means have differing transmission characteristics. As a result, the force transmission means can be separate from each other in respect of function and time, whereby reliability of the power tool can be increased, while at the same time preventing unacceptably high loads on an operator of a power tool having the power tool device. As a result, particularly in the case of jamming, in which high loads can occur, the operator is protected and, at the same time, a sufficiently high torque can be provided, whereby operating comfort of the power tool can be increased, particularly in the case of jamming. A “transmission characteristic” in this case is to be understood to mean, in particular, a sum of properties of a single force transmission means that, in total, define a coupling and/or a force transmission between two rotatable coupling elements, in particular coupling elements that are rotatable relative to each other, of the torque limiting unit. A “differing transmission characteristic” is to be understood to mean, in particular, that at least one property of the one force transmission means differs from a property of the other force transmission means, whereby the at least two force transmission means define differing couplings and/or differing force transmissions. Advantageously, the transmission characteristic is realized as a mechanical transmission characteristic, such as, for example, a sum of frictional forces and/or a sum of compressive forces and/or a sum of actuation forces, whereby, advantageously, the force transmission that is defined by the at least one first force transmission means, for example by a maximally transmissible force and/or a mechanical response behavior and/or an activating behavior, differs from the force transmission that is defined by the at least one second force transmission means. A “force transmission” in this case is to be understood to mean, in particular, a transmission of torque. A “force transmission means” is to be understood to mean, in particular, a means that, for the purpose of transmitting the torque, establishes a coupling between the two coupling elements. Preferably, the at least two force transmission means have the differing transmission characteristics in at least one rotary position of the at least two coupling elements. Particularly preferably, the force transmission means have the differing transmission characteristics in all possible rotary positions of the at least two coupling elements. A “rotary position of the at least two coupling elements” in this case is to be understood to mean, in particular, a position that describes a disposition of the at least two coupling elements relative to each other.

Furthermore, it is proposed that, for the purpose of realizing the differing transmission characteristics, the at least two force transmission means have differing directions of action. As a result, loading of the force transmission means can be reduced in a particularly simple manner, whereby wear on the torque limiting unit can be reduced. A “direction of action” is to be understood to mean, in particular, a direction along which at least a part of the force transmission means can be moved. “Differing directions of action” is to be understood to mean, in particular, directions of action that are asymmetric in relation to a rotation axis, i.e. directions of action that cannot be transformed into each other through a rotary motion about the rotation axis, such as, for example, two directions of action that enclose differing angles with the rotation axis.

Advantageously, at least one of the force transmission means has an at least substantially radial direction of action, and at least one of the force transmission means has an at least substantially axial direction of action. As a result, a particularly advantageous combination of the transmission characteristics can be realized, and utilization of an existing structural space can be increased, whereby a power density of the torque limiting unit can be increased. A “radial direction of action” is to be understood to mean, in particular, a direction of action that is oriented radially, i.e. perpendicularly in relation to a rotation axis of the torque limiting unit. An “axial direction of action” is to be understood to mean, in particular, a direction of action that is oriented axially, i.e. parallelwise in relation to a rotation axis of the torque limiting unit. “Substantially” is to be understood to mean an angular deviation of maximally 5 degrees, preferably maximally 3 degrees, and particularly preferably maximally 1 degree in respect of the axial direction of action or the radial direction of action. Preferably, the rotation axis is realized as a main rotation axis. In principle, the rotation axis can also be realized as a subsidiary rotation axis of the torque limiting unit.

Further, it is proposed that, for the purpose of realizing the differing transmission characteristics, the force transmission means have at least partially differing latching elements, which are provided to transmit the torque for a substantially positive engagement. Degrees of freedom for adapting and optimizing the torque limiting unit can be increased as a result. Preferably, the force transmission means have spring-loaded latching elements.

Preferably, the latching elements of the at least two force transmission means have at least partially differing shapes. As a result, the transmission characteristics can be varied particularly easily, whereby degrees of freedom for adapting and optimizing the torque limiting unit can be provided particularly easily. Preferably, the latching elements can differ, in addition or alternatively, in their material, hardness, size, etc.

Furthermore, it is proposed that, for the purpose of realizing the differing transmission characteristics, the force transmission means have at least partially differing energy storage elements. Degrees of freedom for adapting and optimizing the torque limiting unit can be increased as a result. An “energy storage element” in this case is to be understood to mean, in particular, an element provided to be deformed mechanically through the action of force and to re-deliver this force upon transforming back into an original shape, such as, for example, a spring element or a rubber element.

Advantageously, the energy storage elements of the at least two force transmission means have differing spring constants, whereby, advantageously, an action of the force transmission means can be time-staggered. Advantageously, the energy storage elements can differ, additionally or alternatively, in their material, size, length, type, etc.

Preferably, the torque limiting unit has at least one coupling element, which comprises at least one radially acting engagement contour and at least one axially acting engagement contour. The utilization of the structural space can be further improved as a result. Preferably, the coupling element is realized as a drive element. A “drive element” is to be understood to mean, in particular, an element that is coupled to a drive shaft of the power tool device. “Radially acting” is to be understood to mean, in particular, that an engagement, in particular a substantially positive engagement, in the engagement contour is effected radially, i.e. perpendicularly in relation to the rotation axis of the torque limiting unit. “Axially acting” is to be understood to mean, in particular, that an engagement, in particular a substantially positive engagement, in the engagement contour is effected axially, i.e. parallelwise in relation to the rotation axis of the torque limiting unit.

In an advantageous design, the torque limiting unit has at least one engagement contour, which comprises a latching recess, in which the at least two force transmission means engage positively, at least partially. As a result, alteration of already existing torque limiting units can be reduced, whereby resource requirements and costs can be reduced. Preferably, the engagement contour has at least two latching recesses, in which there engage, respectively, at least two force transmission means, at least partially. Advantageously, the force transmission means engage in the latching recess in a radially offset manner. Preferably, the latching elements of the at least two force transmission means engage in the latching recess. The latching elements engaging in the latching recess can preferably be alike or differing in their realization. An “engagement contour” is to be understood to mean, in particular, a sum of the latching recesses that describes a course of the latching recesses, the engagement contour also being able to have a single latching recess.

In particular, it is advantageous if at least one of the force transmission means is provided for an at least substantially non-positive connection, and at least one of the force transmission means is provided for an at least substantially positive connection. As a result, unwanted dynamic effects can be damped. A “substantially non-positive connection” is to be understood to mean, in particular, a connection in which, between at least two surfaces bearing against each other, a connecting force along the surfaces is greater than a connecting force perpendicular to the surfaces. A “substantially positive connection” is to be understood to mean, in particular, a connection in which, between at least two surfaces bearing against each other, a connecting force perpendicular to the surfaces is greater than a connecting force along the surfaces.

In addition, it is proposed that the torque limiting unit has at least one further force transmission means, which has a transmission characteristic that is the same as one of the at least two force transmission means. As a result, the force transmission means can be configured in a more balanced manner, and a power density of the torque limiting unit can be increased.

In principle, the force transmission means can be disposed around one and the same rotation axis or around two differing rotation axes.

The invention is additionally based on a power tool, in particular a hammer drill and/or hammer chisel, having a power tool device according to the invention. It is thereby possible to provide a power tool having a high degree of reliability and a high degree of protection for the operator.

### DRAWING

Further advantages are given by the following description of the drawing. The drawing shows four exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool realized as a hammer drill,

FIG. 2 shows part of a drive train of the power tool having a power tool device, in a longitudinal section,

FIG. 3 shows a torque limiting unit of the power tool device, in a cross section along section lines III-III,

FIG. 4 shows the torque limiting unit in a longitudinal section along section lines IV-IV,

FIG. 5 shows an alternatively realized torque limiting unit in the longitudinal section along the section lines IV-IV,

FIG. 6 shows a third exemplary embodiment of a torque limiting unit in the cross section along the section lines III-III,

FIG. 7 shows a fourth exemplary embodiment of a torque limiting unit in the longitudinal section along the section lines IV-IV, and

FIG. 8 shows the torque limiting unit from FIG. 7 in a cross section along section lines VIII-VIII.

### DESCRIPTION OF THE EXEMPLARY EMBODIMENTS

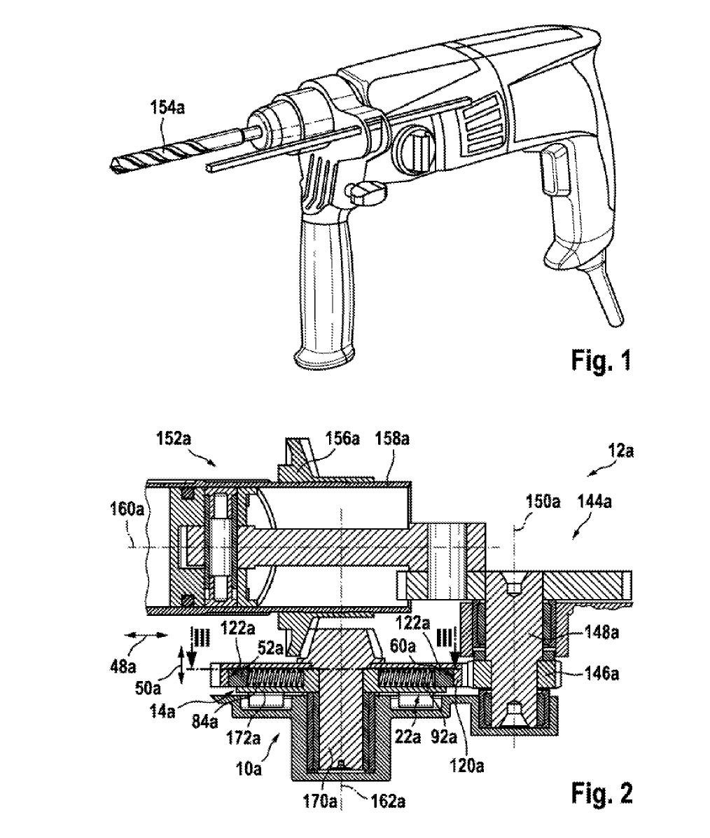

FIG. 1 shows a power tool. The power tool has a power tool device according to the invention. The power tool is realized as a hand power tool. The power tool device is realized as a hand power tool device. The power tool is realized as a hammer drill. The power tool device is realized as a hammer drill device. The power tool device is shown in FIGS. 2 to 4. Represented in FIG. 2 is a portion of a drive train 12a of the power tool comprising the power tool device. FIG. 2 shows a portion of the drive train 12a in a longitudinal section through the power tool.

For the purpose of providing a torque, the power tool device has a drive unit 144a. The drive unit 144a has a transmission element 146a and a drive shaft 148a. The drive shaft 148a has a longitudinal axis 150a. The longitudinal axis 150a corresponds to a rotation axis of the drive shaft 148a. The transmission element 146a is disposed in a rotationally fixed manner on the drive shaft 148a. The drive unit 144a is realized as an eccentric drive. The transmission element 146a is realized as a toothed wheel element that realizes an eccentric spur gear.

For the purpose of outputting the torque, the power tool device has an output unit 152a. By means of the torque, the output unit 152a actuates an insert tool 154a of the power tool. The output unit 152a has a transmission element 156a and an output shaft 158a. The output shaft 158a is fixedly coupled to the insert tool 154a of the power tool. The output shaft 158a has a longitudinal axis 160a. The transmission element 156a is connected to the output shaft 158a, and consequently to the insert tool 154a, in a rotationally fixed manner. The transmission element 156a is disposed on the output shaft 158a so as to be fixed against rotation. The transmission element 156a is realized as a toothed wheel element that realizes a ring gear. The output shaft 158a is realized as a hollow shaft. The output shaft 158a realizes a hammer tube.

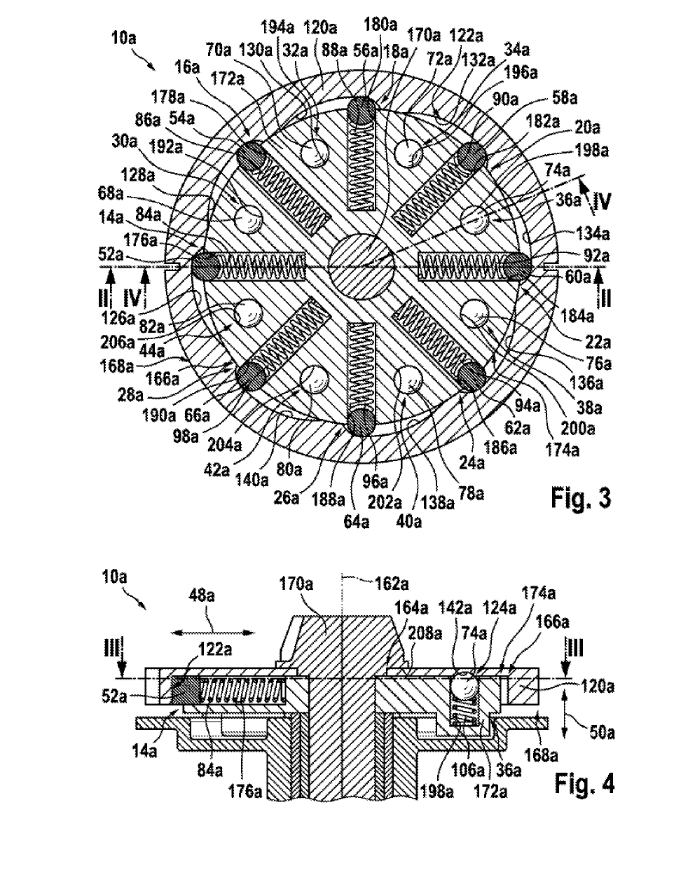

For the purpose of transmitting and limiting the torque in the drive train 12a, the power tool device has a torque limiting unit 10a. The torque limiting unit 10a transmits and limits the torque between the drive unit 144a and the output unit 152a. The torque limiting unit 10a is represented in FIG. 3, in a cross section along the section lines III-III from FIG. 2 and FIG. 4. In FIG. 4, the torque limiting unit 10a is represented in a longitudinal section along section lines IV-IV from FIG. 3. In FIG. 2, the torque limiting unit 10a is represented in a longitudinal section along section lines II-II from FIG. 3.

The torque limiting unit 10a has a main rotation axis 162a. The torque limiting unit 10a transmits the torque about the main rotation axis 162a. It transmits the torque from the drive unit 144a into the output unit 152a. The main rotation axis 162a of the torque limiting unit 10a is oriented parallelwise in relation to the longitudinal axis 150a of the drive unit 144a and perpendicularly in relation to the longitudinal axis 160a of the output unit 152a. The torque limiting unit 10a is realized as a safety coupling. It realizes an overload coupling.

For the purpose of coupling to the drive shaft 148a of the drive unit 144a, the torque limiting unit 10a comprises a first coupling element 120a. The first coupling element 120a is coupled to the transmission element 146a of the drive unit 144a. The first coupling element 120a meshes with the transmission element 146a. The torque provided by the drive unit 144a is transmitted by the transmission element 146a to the first coupling element 120a. The transmission element 146a of the drive unit 144a drives the first coupling element 120a. The first coupling element 120a has a rotation axis that corresponds to the main rotation axis 162a. The first coupling element 120a has an inner circumference 164a, a middle circumference 166a and an outer circumference 168a. The inner circumference 164a, the middle circumference 166a and the outer circumference 168a are each defined by differing diameters. In this case, the diameter that defines the inner circumference 164a is realized so as to be the smallest, and the diameter that defines the outer circumference 168a is realized so as to be the largest. The first coupling element 120a constitutes a first coupling stage of the torque limiting unit 10a. The first coupling element 120a is realized as a coupling spur gear.

The first coupling element 120a has a radially acting engagement contour 122a and an axially acting engagement contour 124a. The radially acting engagement contour 122a runs along the middle circumference 166a of the first coupling element 120a. The radially acting engagement contour runs on a side of the coupling element 120a that faces toward the main rotation axis 162a.

The radially acting engagement contour 122a has eight radial latching recesses 126a, 128a, 130a, 132a, 134a, 136a, 138a, 140a. The latching recesses 126a, 128a, 130a, 132a, 134a, 136a, 138a, 140a extend radially. The latching recesses 126a, 128a, 130a, 132a, 134a, 136a, 138a, 140a constitute the radially acting engagement contour 122a. They are distributed symmetrically around a center point of the coupling element 120a, and consequently around the rotation axis of the first coupling element 120a. They are distributed symmetrically over the middle circumference 166a of the first coupling element 120a. The radial latching recesses 126a, 128a, 130a, 132a, 134a, 136a, 138a, 140a are similar to each other in their realization. The latching recesses 126a, 128a, 130a, 132a, 134a, 136a, 138a, 140a are each realized as a latching groove.

The axially acting engagement contour 124a runs between the inner circumference 164a and the middle circumference 166a of the first coupling element 120a. The axially acting engagement contour 124a runs on a side of the coupling element 120a that faces away from the output unit 152a.

The axially acting engagement contour 124a has eight axial latching recesses, only one axial latching recess 142a being visible in FIGS. 1 to 4. The axial latching recesses 142a constitute the axially acting engagement contour 124a. They are likewise distributed symmetrically around the center point, and consequently around the rotation axis, of the first coupling element 120a. As compared with the radial latching recesses 126a, 128a, 130a, 132a, 134a, 136a, 138a, 140a, the axial latching recesses 142a are disposed closer to the center point, and consequently closer to the rotation axis, of the first coupling element 120a. The axial latching recesses 142a are similar to each other in their realization. The axial latching recesses 142a are each realized as a latching groove. They are each realized as a bore. In principle, the radial latching recesses 126a, 128a, 130a, 132a, 134a, 136a, 138a, 140a and/or the axial latching recesses 142a can be distributed asymmetrically around the rotation axis of the coupling element 120a. Further, alternatively or additionally, the axial latching recesses 142a of the axially acting engagement contour 124a can be at differing radial distances from the center point of the coupling element 120a.

For the purpose of coupling to the output shaft 158a of the output unit 152a, the torque limiting unit 10a comprises a second coupling element 170a. The second coupling element 170a is connected to the transmission element 156a of the output unit 152a. The second coupling element 170a meshes with the transmission element 156a. The second coupling element 170a transmits a torque to the transmission element 156a, and consequently to the output shaft 158a. The second coupling element 170a drives the transmission element 156a of the output unit 152a. The second coupling element 170a has a rotation axis. The rotation axis of the second coupling element 170a corresponds to the main rotation axis 162a of the torque limiting unit 10a. The first coupling element 120a is rotatably mounted on the second coupling element 170a. The second coupling element 170a is realized as a bevel gear pinion.

For the purpose of coupling the first coupling element 120a to the second coupling element 170a, the torque limiting unit 10a has a third coupling element 172a. The third coupling element 172a is provided to transmit the torque from the first coupling element 120a to the second coupling element 170a. The third coupling element 172a has a rotation axis, which corresponds to the main rotation axis 162a. The third coupling element 172a and the second coupling element 170a constitute a second coupling stage of the torque limiting unit 10a.

The third coupling element 172a is connected to the second coupling element 170a in a rotationally fixed manner. The third coupling element 172a is disposed on the second coupling element 170a so as to be fixed against rotation. It is pressed on to the second coupling element 170a. The third coupling element 172a and the first coupling element 120a are disposed coaxially in relation to each other. An outer circumference 174a of the third coupling element 172a is smaller than the outer circumference 168a of the first coupling element 120a. The third coupling element 172a is realized as a coupling disk. The first coupling element 120a, the second coupling element 170a and the third coupling element 172a are provided to transmit the torque from the drive unit 144a to the output unit 152a.

For the purpose of receiving and guiding force transmission means 14a, 16a, 18a, 20a, 22a, 24a, 26a, 28a, 30a, 32a, 34a, 36a, 38a, 40a, 42a, 44a, the third coupling element 172a has eight radial guide channels 176a, 178a, 180a, 182a, 184a, 186a, 188a, 190a, and eight axial guide channels 192a, 194a, 196a, 198a, 200a, 202a, 204a, 206a. The eight radial guide channels 176a, 178a, 180a, 182a, 184a, 186a, 188a, 190a are distributed symmetrically around a center point, and consequently around the rotation axis, of the third coupling element 172a. They are disposed in an offset manner in relation to each other. The eight axial guide channels 192a, 194a, 196a, 198a, 200a, 202a, 204a, 206a are likewise distributed symmetrically around the center point, and consequently around the rotation axis, of the third coupling element 172a.

They are disposed in an offset manner in relation to each other. The guide channels 176a, 178a, 180a, 182a, 184a, 186a, 188a, 190a, 192a, 194a, 196a, 198a, 200a, 202a, 204a, 206a are disposed in an offset manner in relation to each other. In principle, the radial guide channels 176a, 178a, 180a, 182a, 184a, 186a, 188a, 190a and/or the axial guide channels 192a, 194a, 196a, 198a, 200a, 202a, 204a, 206a can be distributed asymmetrically around the rotation axis of the third coupling element 172a. Further, alternatively or additionally, the axial guide channels 192a, 194a, 196a, 198a, 200a, 202a, 204a, 206a can be at differing radial distances from the center point of the coupling element 172a.

The radial guide channels 176a, 178a, 180a, 182a, 184a, 186a, 188a, 190a are similar to each other in their realization, and therefore a description is limited to the radial guide channel 176a. The guide channel 176a runs transversely in relation to the rotation axis of the third coupling element 172a. It runs out from the outer circumference 174a, in the direction of the center point, and consequently in the direction of the rotation axis, of the third coupling element 172a. The radial guide channel 176a is realized as a radial recess in the third coupling element 172a. It is realized as a radial bore.

The axial guide channels 192a, 194a, 196a, 198a, 200a, 202a, 204a, 206a are likewise similar to each other in their realization, and therefore a description is limited to the axial guide channel 198a. The guide channel 198a runs parallelwise in relation to the rotation axis of the third coupling element 172a. It runs out from a surface 208a that faces toward the first coupling element 120a, parallelwise in relation to the rotation axis of the coupling element 172a. The axial guide channel 198a is realized as an axial recess in the third coupling element 172a. It is realized as an axial bore.

For the purpose of positively coupling the first coupling element 120a to the third coupling element 172a, and consequently to the second coupling element 170a, the torque limiting unit 10a has the sixteen force transmission means 14a, 16a, 18a, 20a, 22a, 24a, 26a, 28a, 30a, 32a, 34a, 36a, 38a, 40a, 42a, 44a. The force transmission means 14a, 16a, 18a, 20a, 22a, 24a, 26a, 28a, 30a, 32a, 34a, 36a, 38a, 40a, 42a, 44a transmit the torque from the first coupling element 120a to the third coupling element 172a, and consequently to the second coupling element 170a. The sixteen force transmission means 14a, 16a, 18a, 20a, 22a, 24a, 26a, 28a, 30a, 32a, 34a, 36a, 38a, 40a, 42a, 44a are provided to limit the transmitting torque of the torque limiting unit 10a.

The torque limiting unit 10a has a first force transmission group and a second force transmission group. The first force transmission group comprises eight same-type force transmission means 14a, 16a, 18a, 20a, 22a, 24a, 26a, 28a. The second force transmission group comprises eight same-type force transmission means 30a, 32a, 34a, 36a, 38a, 40a, 42a, 44a. The eight same-type force transmission means 14a, 16a, 18a, 20a, 22a, 24a, 26a, 28a of the first force transmission group are distributed symmetrically around the main rotation axis 162a. They are disposed, in a radially offset manner in relation to each other, in the third coupling element 172a. The eight same-type force transmission means 30a, 32a, 34a, 36a, 38a, 40a, 42a, 44a of the second force transmission group are likewise distributed symmetrically around the main rotation axis 162a. They are disposed, in a radially offset manner in relation to each other, in the third coupling element 172a. The same-type force transmission means 30a, 32a, 34a, 36a, 38a, 40a, 42a, 44a of the second force transmission group are at the same radial distance from the main rotation axis 162a. All force transmission means 14a, 16a, 18a, 20a, 22a, 24a, 26a, 28a, 30a, 32a, 34a, 36a, 38a, 40a, 42a, 44a are distributed symmetrically around the main rotation axis 162a and disposed, in an offset manner in relation to each other, in the third coupling element 172a. The first force transmission group and the second force transmission group each realize a positive coupling, such that the torque limiting unit 10a is realized as a purely positive coupling.

In principle, the force transmission means 14a, 16a, 18a, 20a, 22a, 24a, 26a, 28a of the first force transmission group and/or the force transmission means 30a, 32a, 34a, 36a, 38a, 40a, 42a, 44a of the second force transmission group can be distributed asymmetrically around the main rotation axis 162a. Further, alternatively or additionally, the energy storage elements 30a, 32a, 34a, 36a, 38a, 40a, 42a, 44a of the second force transmission group can be at differing radial distances from the main rotation axis 162a.

For the purpose of limiting the transmitting torque, the force transmission means 14a, 16a, 18a, 20a, 22a, 24a, 26a, 28a, 30a, 32a, 34a, 36a, 38a, 40a, 42a, 44a each have a latching element 52a, 54a, 56a, 58a, 60a, 62a, 64a, 66a, 68a, 70a, 72a, 74a, 76a, 78a, 80a, 82a and each have an energy storage element 84a, 86a, 88a, 90a, 92a, 94a, 96a, 98a, 106a. For the purpose of transmitting the torque, the latching elements 52a, 54a, 56a, 58a, 60a, 62a, 64a, 66a in this case each engage substantially in a positive manner in a radial latching recess 126a, 128a, 130a, 132a, 134a, 136a, 138a, 140a of the radially acting engagement contour 122a, and the latching elements 68a, 70a, 72a, 74a, 76a, 78a, 80a, 82a each engage substantially in a positive manner in an axial latching recess 142a of the axially acting engagement contour 124a. The force transmission means 14a, 16a, 18a, 20a, 22a, 24a, 26a, 28a, 30a, 32a, 34a, 36a, 38a, 40a, 42a, 44a are each realized as a pressure piece.

As compared with the eight same-type force transmission means 30a, 32a, 34a, 36a, 38a, 40a, 42a, 44a, the eight same-type force transmission means 14a, 16a, 18a, 20a, 22a, 24a, 26a, 28a have different transmission characteristics. Thus, the first force transmission group has different transmission characteristics, as compared with the second force transmission group. For the purpose of realizing the differing transmission characteristics, the eight same-type force transmission means 14a, 16a, 18a, 20a, 22a, 24a, 26a, 28a of the first force transmission group have a different direction of action 48a, 50a, as compared with the eight same-type force transmission means 30a, 32a, 34a, 36a, 38a, 40a, 42a, 44a of the second force transmission group.

For the purpose of realizing the differing directions of action 48a, 50a, the same-type force transmission means 14a, 16a, 18a, 20a, 22a, 24a, 26a, 28a of the first force transmission group are disposed in the radial guide channels 176a, 178a, 180a, 182a, 184a, 186a, 188a, 190a, and the same-type force transmission means 30a, 32a, 34a, 36a, 38a, 40a, 42a, 44a of the second force transmission group are disposed in the axial guide channels 192a, 194a, 196a, 198a, 200a, 202a, 204a, 206a. The direction of action 48a of the force transmission means 14a, 16a, 18a, 20a, 22a, 24a, 26a, 28a of the first force transmission group runs perpendicularly in relation to the main rotation axis 162a, and therefore runs radially. The eight force transmission means 14a, 16a, 18a, 20a, 22a, 24a, 26a, 28a of the first force transmission group therefore have a radial direction of action 48a. The direction of action 50a of the force transmission means 30a, 32a, 34a, 36a, 38a, 40a, 42a, 44a of the second force transmission group runs along the main rotation axis 162a, and therefore runs axially. The eight force transmission means 30a, 32a, 34a, 36a, 38a, 40a, 42a, 44a of the second force transmission group therefore have an axial direction of action 50a. The axial direction of action 50a is oriented parallelwise in relation to the main rotation axis 162a.

The eight force transmission means 14a, 16a, 18a, 20a, 22a, 24a, 26a, 28a of the first force transmission group are realized so as to be of the same type, i.e. the eight force transmission means 14a, 16a, 18a, 20a, 22a, 24a, 26a, 28a have the same transmission characteristic. The eight force transmission means 14a, 16a, 18a, 20a, 22a, 24a, 26a, 28a of the first force transmission group are similar to each other in their realization, and therefore a description is limited to the force transmission means 14a of the first force transmission group. The force transmission means 14a is disposed in the radial guide channel 176a. The force transmission means 14a comprises the latching element 52a and the energy storage element 84a having a spring constant.

The energy storage element 84a presses the latching element 52a into the radial latching recess 126a of the radially acting engagement contour 122a. The latching element 52a engaging in the radial latching recess 126a establishes a substantially positive connection between the first coupling element 120a and the third coupling element 172a. The energy storage element 84a is realized as a cylindrical helical compression spring.

The eight force transmission means 30a, 32a, 34a, 36a, 38a, 40a, 42a, 44a of the second force transmission group are realized so as to be of the same type, i.e. the eight force transmission means 30a, 32a, 34a, 36a, 38a, 40a, 42a, 44a have the same transmission characteristic. The eight force transmission means 30a, 32a, 34a, 36a, 38a, 40a, 42a, 44a of the second force transmission group are similar to each other in their realization, and therefore a description is limited to the force transmission means 36a of the second force transmission group. The force transmission means 36a is disposed in the axial guide channel 198a. The force transmission means 36a comprises the latching element 74a and the energy storage element 106a having a spring constant. In FIGS. 1 to 4, only the energy storage element 106a of the force transmission means 36a is visible.

The energy storage element 106a presses the latching element 74a into the axial latching recess 142a of the axially acting engagement contour 124a. The latching element 74a engaging in the axial latching recess 142a establishes a substantially positive connection between the first coupling element 120a and the third coupling element 172a. The energy storage element 106a is realized as a cylindrical helical compression spring.

For the purpose of additionally realizing the different transmission characteristic of the force transmission means 14a of the first force transmission group as compared with the force transmission means 36a of the second force transmission group, the latching elements 52a, 74a and the energy storage elements 84a, 106a of the force transmission means 14a, 36a differ in their realization. The latching element 52a of the force transmission means 14a of the first force transmission group and the latching element 74a of the force transmission means 36a of the second force transmission group have differing shapes, for the purpose of realizing the differing transmission characteristics.

The latching element 52a of the force transmission means 14a of the first force transmission group has a cylindrical shape. It is realized as a cylinder. Consequently, the latching element 52a has a cylindrical bearing contact surface. The latching element 52a lies with the cylindrical bearing contact surface in the radial latching recess 126a of the radially acting engagement contour 122a. The latching element 74a of the force transmission means 36a of the second force transmission group has a spherical shape. It is realized as a sphere. Consequently, the latching element 74a has a spherical bearing contact surface. The latching element 74a lies with the spherical bearing contact surface in the axial latching recess 142a of the axially acting engagement contour 124a.

The energy storage element 84a of the force transmission means 14a of the first force transmission group and the energy storage element 106a of the force transmission means 36a of the second force transmission group have differing spring constants, for the purpose of additionally realizing the differing transmission characteristics.

The transmission characteristic of the eight same-type force transmission means 14a, 16a, 18a, 20a, 22a, 24a, 26a, 28a of the first force transmission group differs from the transmission characteristic of the eight same-type force transmission means 30a, 32a, 34a, 36a, 38a, 40a, 42a, 44a of the second force transmission group in the radial direction of action 48a of the first force transmission group and the axial direction of action 50a of the second force transmission group, in the shape of the latching elements 52a, 54a, 56a, 58a, 60a, 62a, 64a, 66a, of the first force transmission group and the latching elements 68a, 70a, 72a, 74a, 76a, 78a, 80a, 82a of the second force transmission group, and in the spring constants of the energy storage elements 84a, 86a, 88a, 90a, 92a, 94a, 96a, 98a of the first force transmission group and the spring constants of the energy storage elements 106a of the second force transmission group.

In an operating state in which the insert tool 154a of the power tool becomes jammed, the output unit 152a, and consequently the output shaft 158a, the transmission element 156a and the second coupling element 170a are braked abruptly, while the drive unit 144a provides a torque in an undiminished manner. If a defined overlatching moment is then exceeded in the torque limiting unit 10a, the energy storage elements 84a, 86a, 88a, 90a, 92a, 94a, 96a, 98a of the force transmission means 14a, 16a, 18a, 20a, 22a, 24a, 26a, 28a of the first force transmission group and the energy storage elements 106a of the force transmission means 30a, 32a, 34a, 36a, 38a, 40a, 42a, 44a of the second force transmission group yield in a time-staggered manner, as a result of which the latching elements 52a, 54a, 56a, 58a, 60a, 62a, 64a, 66a of the force transmission means 14a, 16a, 18a, 20a, 22a, 24a, 26a, 28a of the first force transmission group and the latching elements 68a, 70a, 72a, 74a, 76a, 78a, 80a, 82a of the force transmission means 30a, 32a, 34a, 36a, 38a, 40a, 42a, 44a of the second force transmission group are pressed, in a time-staggered manner, against a spring force of the corresponding energy storage element 84a, 86a, 88a, 90a, 92a, 94a, 96a, 98a, 106a, into the respective guide channel 176a, 178a, 180a, 182a, 184a, 186a, 188a, 190a, 192a, 194a, 196a, 198a, 200a, 202a, 204a, 206a, and consequently out of the respective latching recess 126a, 128a, 130a, 132a, 134a, 136a, 138a, 140a, 142a. As a result, the positive connection between the first coupling element 120a and the third coupling element 172a, established by the force transmission means 14a, 16a, 18a, 20a, 22a, 24a, 26a, 28a, 30a, 32a, 34a, 36a, 38a, 40a, 42a, 44a, becomes undone in a time-staggered manner, such that the transmitting torque of the torque limiting unit 10a is limited. In principle, the force transmission means 14a, 16a, 18a, 20a, 22a, 24a, 26a, 28a, 30a, 32a, 34a, 36a, 38a, 40a, 42a, 44a can also be realized such that the positive connection between the first coupling element 120a and the third coupling element 172a becomes undone simultaneously.

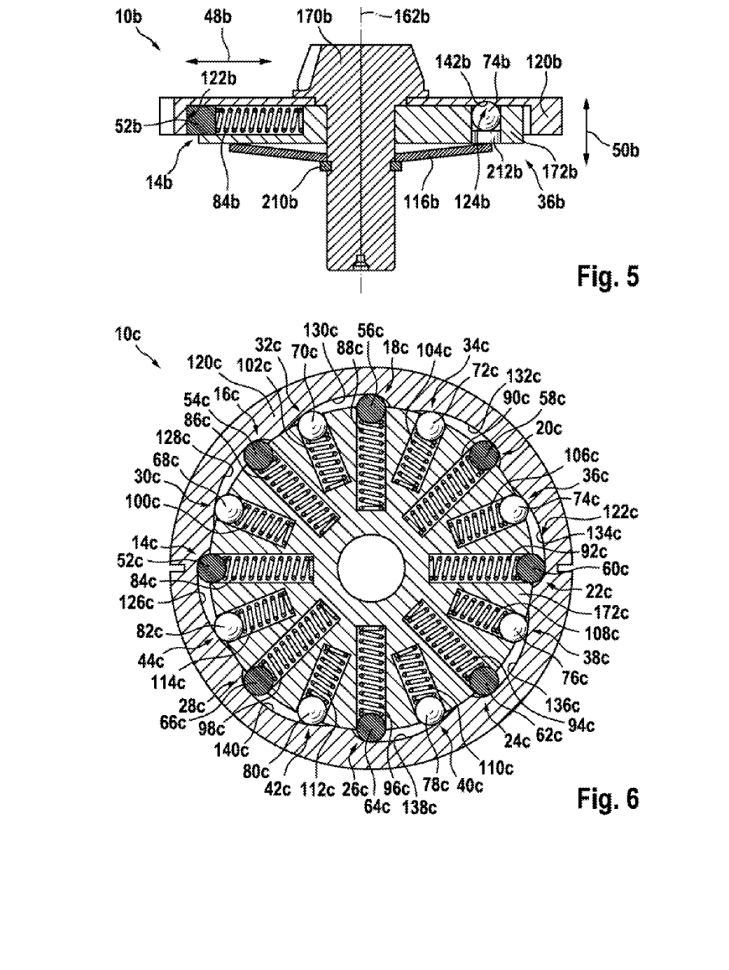

Three alternative exemplary embodiments are represented in FIGS. 5 to 8. Components, features and functions that remain substantially the same are denoted, basically, by the same references. In order to differentiate the exemplary embodiments, the references of the exemplary embodiments have the suffix letters a to d. The description that follows is limited substantially to the differences in relation to the first exemplary embodiment in FIGS. 1 to 4, and reference may be made to the description of the first exemplary embodiment in FIGS. 1 to 4 in respect of components, features and functions that remain the same.

FIG. 5 shows a longitudinal section of an alternative torque limiting unit 10b of a power tool device for limiting and transmitting a torque about a main rotation axis 162b in a drive train of a power tool realized as a hammer drill. The power tool in this case has a structure similar to that of the power tool shown in FIG. 1, and the power tool device has a structure similar to that of the power tool device shown in FIG. 2.

For the purpose of positively connecting a first coupling element 120b to a third coupling element 172b, and consequently to a second coupling element, the torque limiting unit 10b has sixteen force transmission means, with only the force transmission means 14b, 36b being visible in FIG. 5. The force transmission means 14b, 36b transmit the torque from the first coupling element 120b to the third coupling element 172b, and consequently to the second coupling element 170b. The force transmission means 14b, 36b are provided to limit the transmitting torque of the torque limiting unit 10b. For this purpose, the force transmission means 14b, 36b are each realized as a pressure piece.

The torque limiting unit 10b has a first force transmission group, which comprises eight same-type force transmission means, which in their realization are similar to the force transmission means 14b. The torque limiting unit 10b has a second force transmission group, which comprises eight same-type force transmission means, which in their realization are similar to the force transmission means 36b. The force transmission means 14b and the force transmission means 36b have differing transmission characteristics. The transmission characteristic of the force transmission means 14b differs from the transmission characteristic of the force transmission means 36b in the differing directions of action 48b, 50b, in a differing shape of latching elements 52b, 74b, and in a differing spring constant of energy storage elements 84b, 116b.

In distinction from the previous exemplary embodiment, the force transmission means 36b of the second force transmission group comprise the single energy storage element 116b. The energy storage element 116b is realized as a central, common energy storage element of the force transmission means 36b of the second force transmission group. The central energy storage element 116b actuates jointly the latching elements 74b of the force transmission means 36b of the second force transmission group, and presses the eight latching elements 74b into corresponding axial latching recesses 142b of an axially acting engagement contour 124b in the first coupling element 120b. The central energy storage element 116b is supported on a supporting element 210b, which is fixedly connected to the second coupling element 170b. The central energy storage element 116b is realized as a disk spring.

In this exemplary embodiment, the central energy storage element 116b acts indirectly upon the latching elements 74b of the force transmission means 36b of the second force transmission group. For this purpose, each force transmission means 36b of the second force transmission group has an intermediate element 212b, only the intermediate piece 212b of the force transmission means 36b being visible. The energy storage element 116b acts upon the corresponding latching element 74b via the corresponding intermediate piece 212b. The intermediate piece 212b is in each case disposed between the latching element 74b and the energy storage element 116b. The intermediate pieces 212b of the force transmission means 36b of the second force transmission group are each realized as spacer blocks. In principle, the central energy storage element 116b can also act directly upon the latching elements 74b of the second force transmission group, such that it is possible to dispense with intermediate pieces 212b.

FIG. 6 shows a third exemplary embodiment of a power tool device. Represented in FIG. 6 is a cross section of a torque limiting unit 10c of the power tool device for limiting and transmitting a torque about a main rotation axis of the torque limiting unit 10c in a drive train of a power tool realized as a hammer drill. The power tool in this case has a structure similar to that of the power tool shown in FIG. 1, and the power tool device has a structure similar to that of the power tool device shown in FIG. 2.

For the purpose of positively connecting a first coupling element 120cto a third coupling element 172c, and consequently to a second coupling element, the torque limiting unit 10c has sixteen force transmission means, 14c, 16c, 18c, 20c, 22c, 24c, 26c, 28c, 30c, 32c, 34c, 36c, 38c, 40c, 42c, 44c. The force transmission means, 14c, 16c, 18c, 20c, 22c, 24c, 26c, 28c, 30c, 32c, 34c, 36c, 38c, 40c, 42c, 44c transmit the torque from the first coupling element 120c to the third coupling element 172c, and consequently to the second coupling element. The force transmission means 14c, 16c, 18c, 20c, 22c, 24c, 26c, 28c, 30c, 32c, 34c, 36c, 38c, 40c, 42c, 44c are provided to limit the transmitting torque of the torque limiting unit 10c. For this purpose, the force transmission means 14c, 16c, 18c, 20c, 22c, 24c, 26c, 28c, 30c, 32c, 34c, 36c, 38c, 40c, 42c, 44c are each realized as a pressure piece.

In distinction from the previous exemplary embodiments, the first coupling element 120c has only radial latching recesses 126c, 128c, 130c, 132c, 134c, 136c, 138c, 140c, and consequently only a radially acting engagement contour 122c. Further, in distinction from the previous exemplary embodiments, the third coupling element 172c has only radial guide channels, the guide channels being disposed in a radially offset manner in relation to each other.

The torque limiting unit 10c has a first force transmission group, which comprises eight same-type force transmission means 14c, 16c, 18c, 20c, 22c, 24c, 26c, 28c. The torque limiting unit 10c has a second force transmission group, which comprises eight same-type force transmission means 30c, 32c, 34c, 36c, 38c, 40c, 42c, 44c. The force transmission means 14c, 16c, 18c, 20c, 22c, 24c, 26c, 28c of the first force transmission group and the force transmission means 30c, 32c, 34c, 36c, 38c, 40c, 42c, 44c of the second force transmission group have differing transmission characteristics.

The force transmission means 14c, 16c, 18c, 20c, 22c, 24c, 26c, 28c, 30c, 32c, 34c, 36c, 38c, 40c, 42c, 44c each have a latching element 52c, 54c, 56c, 58c, 60c, 62c, 64c, 66c, 68c, 70c, 72c, 74c, 76c, 78c, 80c, 82c, and each have an energy storage element 84c, 86c, 88c, 90c, 92c, 94c, 96c, 98c, 100c, 102c, 104c, 106c, 108c, 110c, 112c, 114c. In this exemplary embodiment, respectively one latching element 52c, 54c, 56c, 58c, 60c, 62c, 64c, 66c of the force transmission means 14c, 16c, 18c, 20c, 22c, 24c, 26c, 28c of the first force transmission group and respectively one latching element 68c, 70c, 72c, 74c, 76c, 78c, 80c, 82c of the force transmission means 30c, 32c, 34c, 36c, 38c, 40c, 42c, 44c of the second force transmission group engage in one and the same latching recess 126c, 128c, 130c, 132c, 134c, 136c, 138c, 140c in a substantially positive manner.

The eight force transmission means 14c, 16c, 18c, 20c, 22c, 24c, 26c, 28c of the first force transmission group are realized so as to be of the same type, i.e. the eight force transmission means 14c, 16c, 18c, 20c, 22c, 24c, 26c, 28c have the same transmission characteristic. The eight force transmission means 14c, 16c, 18c, 20c, 22c, 24c, 26c, 28c are each disposed in a radial guide channel of the third coupling element 172c, and therefore have a radial direction of action. The eight force transmission means 14c, 16c, 18c, 20c, 22c, 24c, 26c, 28c of the first force transmission group are similar to each other in their realization, and therefore a description is limited to the force transmission means 14c of the first force transmission group. The force transmission means 14c engages in the radial latching recess 126c of the radially acting engagement contour 122c of the first coupling element 120c. The force transmission means 14c comprises the latching element 52c and the energy storage element 84c having a spring constant.

The eight force transmission means 30c, 32c, 34c, 36c, 38c, 40c, 42c, 44c of the second force transmission group are realized so as to be of the same type, i.e. the eight force transmission means 30c, 32c, 34c, 36c, 38c, 40c, 42c, 44c have the same transmission characteristic. The eight force transmission means 30c, 32c, 34c, 36c, 38c, 40c, 42c, 44c are each likewise disposed in a radial guide channel of the third coupling element 172c, and therefore likewise have a radial direction of action. The eight force transmission means 30c, 32c, 34c, 36c, 38c, 40c, 42c, 44c of the second force transmission group are similar to each other in their realization, and therefore a description is limited to the force transmission means 44c of the second force transmission group. The force transmission means 44c likewise engages in the radial latching recess 126c of the radially acting engagement contour 122c of the first coupling element 120c. The force transmission means 14c comprises the latching element 82c and the energy storage element 114c having a spring constant, the spring constant of the energy storage element 114c differing from the spring constant of the energy storage element 84c.

The force transmission means 14c of the first force transmission group and the force transmission means 44c of the second force transmission group engage, in a radially offset manner in relation to each other, in one and the same radial latching recess 126c, such that the transmission characteristics of the force transmission means 14c, 44c differ from each other. Respectively, one force transmission means 14c, 16c, 18c, 20c, 22c, 24c, 26c, 28c of the first force transmission group and one force transmission means 30c, 32c, 34c, 36c, 38c, 40c, 42c, 44c of the second force transmission group engage, in a radially offset manner in relation to each other, in one and the same radial latching recess 126c, 128c, 130c, 132c, 134c, 136c, 138c, 140c.

All sixteen force transmission means 14c, 16c, 18c, 20c, 22c, 24c, 26c, 28c, 30c, 32c, 34c, 36c, 38c, 40c, 42c, 44c therefore have the same direction of action. The force transmission means 14c, 16c, 18c, 20c, 22c, 24c, 26c, 28c of the first force transmission group and the force transmission means 30c, 32c, 34c, 36c, 38c, 40c, 42c, 44c of the second force transmission group have a radial direction of action.

In this exemplary embodiment, the transmission characteristic of the force transmission means 14c, 16c, 18c, 20c, 22c, 24c, 26c, 28c of the first force transmission group differs from the transmission characteristic of the force transmission means 30c, 32c, 34c, 36c, 38c, 40c, 42c, 44c in the shape of the latching elements 52c, 54c, 56c, 58c, 60c, 62c, 64c, 66c of the first force transmission group and the latching elements 68c, 70c, 72c, 74c, 76c, 78c, 80c, 82c of the second force transmission group, in the spring constants of the energy storage elements 84c, 86c, 88c, 90c, 92c, 94c, 96c, 98c of the first force transmission group and the spring constants of the energy storage elements 100c, 102c, 104c, 106c, 108c, 110c, 112c, 114c of the second force transmission group, and in the radially offset engagement in one and the same latching recess 126c, 128c, 130c, 132c, 134c, 136c, 138c, 140c by, respectively, one latching element 52c, 54c, 56c, 58c, 60c, 62c, 64c, 66c of the first force transmission group and one latching element 68c, 70c, 72c, 74c, 76c, 78c, 80c, 82c of the second force transmission group.

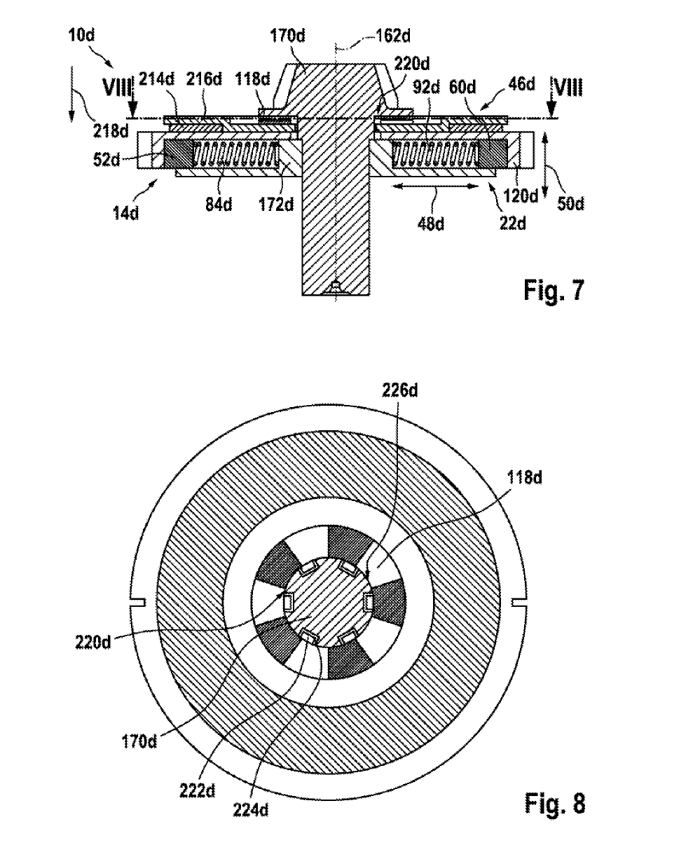

FIGS. 7 and 8 show a fourth exemplary embodiment of a power tool device. Represented in FIG. 7 is a longitudinal section, and in FIG. 8 a cross section, of a torque limiting unit 10d of the power tool device for limiting and transmitting a torque about a main rotation axis 162d in a drive train of a power tool realized as a hammer drill. The power tool in this case has a structure similar to that of the power tool shown in FIG. 1, and the power tool device has a structure similar to that of the power tool device shown in FIG. 2.

In distinction from the previous exemplary embodiments, the torque limiting unit 10d for limiting a transmitting torque of the torque limiting unit 10d has nine force transmission means, only three force transmission means 14d, 22d, 46d being visible in FIGS. 7 and 8. The nine force transmission means 14d, 22d, 46d transmit the torque from a first coupling element 120d to a third coupling element 172d, and consequently to a second coupling element 170d.

The torque limiting unit 10d has a force transmission group, which comprises eight same-type force transmission means, which in their realization are similar to the two force transmission means 14d, 22d. Further, the torque limiting unit 10d comprises the force transmission means 46d, which, in a transmission characteristic, differs from the force transmission means 14d, 22d. In principle, the torque limiting unit 10d can have a second force transmission group, which comprises a plurality of same-type force transmission means that in their realization are similar to the force transmission means 46d.

For the purpose of realizing the differing transmission characteristics, the force transmission means 14d, 22d of the force transmission group connect the first coupling element 120d and the third coupling element 172d to each other in a positive manner, and the force transmission means 46d connects the first coupling element 120d and the second coupling element 172d, and consequently the third coupling element 170d, to each other in a non-positive manner. For the purpose of further realizing the differing transmission characteristics, the force transmission means 14d, 22d of the force transmission group have a radial direction of action 48d and the force transmission means 46d has an axial direction of action 50d.

In distinction from the previous exemplary embodiments, the force transmission means 14d, 22d of the force transmission group realize a positive coupling, and the force transmission means 46d realizes a non-positive coupling. The force transmission means 14d, 22d of the force transmission group each have a latching element 52d, 60d and an energy storage element 84d, 92d having, in each case, a spring constant, the latching elements 52d, 60d and the energy storage elements 84d, 92d being similar in their realization. The torque limiting unit 10d is thus realized as a combined positive and non-positive coupling.

The force transmission means 46d has a friction element 214d, a connecting element 216d and an energy storage element 118d. The friction element 214d, the connecting element 216d and the energy storage element 118d are disposed coaxially in relation to each other.

The friction element 214d is provided to non-positively connect the first coupling element 120d and the second coupling element 172d. The friction element 214d is disposed, with respect to a direction 218d oriented parallelwise in relation to the main rotation axis 162d, between the first coupling element 120d and the connecting element 216d. The friction element 214d bears against the first coupling element 120d and against the connecting element 216d. The friction element 214d is fixedly connected to the first coupling element 120d. The friction element 214d is realized as a friction disk.

The connecting element 216d is provided to transmit the torque from the first coupling element 120d to the second coupling element 170d. The connecting element 216d is positively coupled to the second coupling element 170d and, via the friction element 214d, non-positively coupled to the first coupling element 120d. The connecting element 216d has a toothing 222d on its inner circumference 220d. The toothing 222d of the connecting element 216d is realized so as to correspond to a toothing 224d on an outer circumference 226d of the second coupling element 170d. The toothing 222d of the connecting element 216d engages in the toothing 224d of the second coupling element 170d, as a result of which the connecting element 216d and the second coupling element 170d are positively connected to each other. The connecting element 216d is disposed, in the direction 218d oriented parallelwise in relation to the main rotation axis 162d, between the first coupling element 120d and the energy storage element 118d. The connecting element 216d is realized as a driver disk. The toothing 222d is realized as a driving toothing.

The energy storage element 118d is provided to provide a necessary pressure of the connecting element 216d on to the friction element 214d. The energy storage element 118d presses the connecting element 216d on to the friction element 214d. The energy storage element 118d is disposed, in the direction 218d oriented parallelwise in relation to the main rotation axis 162d, between the second coupling element 170d and the connecting element 216d. It is supported on the second coupling element 170d and the connecting element 216d. The energy storage element 118d has a spring constant that differs from the spring constants of the energy storage elements 84d, 92d of the force transmission means 14d, 22d. The energy storage element 118d is realized as a waved spring.

The transmission characteristic of the force transmission means 14d, 22d of the force transmission group differs from the transmission characteristic of the force transmission means 46d in the radial direction of action 48d of the force transmission group and the axial direction of action 50d of the force transmission means 46d, and in the positive connection of the coupling elements 120d, 172d by the force transmission group and the non-positive connection of the coupling elements 120d, 170d by the force transmission means 46d.

In an operating state in which the insert tool of the power tool becomes jammed, the second coupling element 170d is braked abruptly, while the first coupling element 120d continues to rotate in an undiminished manner. Owing to the force transmission means 46d, a relative motion involving friction is produced, as a result of which the second coupling element 170d is driven permanently by the first coupling element 120d. The force transmission means 46d thus transmits a continuous torque having a constant amplitude. In addition, the force transmission means 14d, 22d of the first force transmission group transmit a varying overlatching moment, which results from a varying latching-in and latching-out of the latching elements 52d, 60d. The continuous torque is thus superimposed on the varying overlatching moment.

1. A power tool device, comprising:
at least one torque limiting unit configured to limit a torque in a drive train in at least one operating state, the at least one torque limiting unit including at least two force transmission mechanisms configured to transmit the torque in the at least one operating state,
wherein the at least two force transmission mechanisms have differing transmission characteristics.

2. The power tool device as claimed in claim 1, wherein the at least two force transmission mechanisms have differing directions of action so as to realize the differing transmission characteristics.

3. The power tool device as claimed in claim 1, wherein at least one of the force transmission mechanisms has an at least substantially radial direction of action, and wherein at least one of the force transmission mechanisms has an at least substantially axial direction of action.

4. The power tool device as claimed in claim 1, wherein the force transmission mechanisms have at least partially differing latching elements configured to transmit the torque for a substantially positive engagement so as to realize the differing transmission characteristics.

5. The power tool device as claimed in claim 4, wherein the latching elements of the at least two force transmission mechanisms have at least partially differing shapes.

6. The power tool device as claimed in claim 1, wherein the force transmission mechanisms have at least partially differing energy storage elements so as to realize the differing transmission characteristics.

7. The power tool device as claimed in claim 6, wherein the energy storage elements of the at least two force transmission mechanisms have differing spring constants.

8. The power tool device as claimed in claim 1, wherein the torque limiting unit has at least one coupling element that includes at least one radially acting engagement contour and at least one axially acting engagement contour.

9. The power tool device as claimed in claim 1, wherein the torque limiting unit has at least one engagement contour that forms a latching recess into which the at least two force transmission mechanisms at least partially and positively engage.

10. The power tool device as claimed in claim 1, wherein at least one of the force transmission mechanisms is configured for an at least substantially non-positive connection, and wherein at least one of the force transmission mechanisms is configured for an at least substantially positive connection.

11. The power tool device as claimed in claim 1, wherein the torque limiting unit has at least one further force transmission mechanism that has a transmission characteristic that is the same as one of the at least two force transmission mechanisms.

12. A power tool, comprising:
a power tool device including:
at least one torque limiting unit configured to limit a torque in a drive train in at least one operating state, the at least one torque limiting unit including at least two force transmission mechanisms configured to transmit the torque in the at least one operating state,
wherein the at least two force transmission mechanisms have differing transmission characteristics.

13. The power tool device as claimed in claim 1, wherein the power tool device is one or more of a hammer drill device and a chisel drill device.

14. The power tool as claimed in claim 12, wherein the power tool is one or more of a hammer drill and a hammer chisel.
